(19) United States
(12) Patent Application Publication
(10) Pub. No.: US 2004/0143540 A1
(43) Pub. Date: Jul. 22, 2004

(54) Electronic sales system and method for price bargaining

(76) Inventor: Keun-Ho Song, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/724,032

(22) Filed: Nov. 26, 2003

Related U.S. Application Data
(63) Continuation of application No. PCT/KR02/01021, filed on May 30, 2002.

(30) Foreign Application Priority Data
May 31, 2001 (KR) 2001/30596

(51) Int. Cl. G06F 17/60

(52) U.S. Cl. 705/37; 705/26

(57) ABSTRACT

Disclosed are an electronic commerce system and a method for negotiating a price on a network. The system has a negotiation management server for controlling a series of functions for price negotiations between first and second clients; a price negotiation engine including a registration module for registering goods data and negotiation environment data, a negotiation progress module for progressing the price negotiations between the first and second clients and a calculation module for calculating the degree of negotiation intention; and a database server for storing information on sellers and purchasers, data on registered goods, registered goods information on negotiation environment data, trade details and approval details. The present invention provides reasonable electronic commerce by deciding a trade price through 1 to 1 price negotiations between seller and purchasers on the network and allows simpler goods registration.

### RELATED APPLICATIONS

This application is a continuing application under 35 U.S.C. § 365 (c) claiming the benefit of the filing date of PCT Application No. PCT/KR02/01021 designating the United States, filed May 30, 2002. The PCT Application was published in English as WO 02/09697 A1 on Dec. 5, 2002, and claims the benefit of the earlier filing date of Korean Patent Application No. 2001/30596, filed May 31, 2001. The contents of the PCT Application including its international publication and Korean Patent Application Nos. 2001/30596 are incorporated herein by reference in their entirety.

### BACKGROUND OF THE INVENTION

1Field of Technology

The present invention relates to electronic commerce, and more particularly to electronic price bargaining.

2. Discussion of Related Technology

Nowadays, with wide prevalence of computer systems and rapid development and spread of networks, electronic shopping malls using such networks are being on the rise as significant commerce ways. Such electronic commerce systems overcome regional, temporal and spatial restraints on selling or purchasing, simplify distribution steps and support on-line approval by providing a variety of information on goods and selling and purchasing thereof on a network, so that activation of an electronic commerce is promoted and, accordingly, industrial economic activities are smoothly performed and speeded.

However, since conventional electronic commerce had one-sided fixed price systems centered on sellers, predetermined delivery methods, approval ways, etc., there was a troublesomeness of collecting information while surfing a number of shopping malls in order that purchasers buy goods for more reasonable prices and conditions.

In addition, since the electronic commerce such as an auction sale induces excessive price competition in public during a predetermined period of time in a price competitive way, there was a problem in that it was difficult for a number of sellers or purchasers to be put in a reasonable price competition and to have opportunities to sell and purchase goods in a variety of conditions.

Furthermore, in the electronic commerce, due to lack of the formation of a trade price based on not only a trade quantity for the trade price but also non-price trade factors such as goods delivery term, quality guaranteed term, returns conditions, payment means, package level, and the number of the recommended, there was another problem in that a variety of opinions and conditions between sellers and purchasers were seldom converged into an agreement.

Meanwhile, in a conventional electronic commerce, when the sellers or the purchasers were to register goods to be sold or purchased into various electronic shopping malls, there was a troublesomeness of fully inputting the information on goods to be registered.

### SUMMARY OF THE INVENTION

One aspect of the present invention provides a system for electronic bargaining for sale of goods. The system comprises: means for storing information identifying goods for sale and a price range defined by highest and lowest selling prices of the goods; means for receiving a desired price of goods for sale; means for determining whether the desired price falls within the price range including the highest and lowest selling prices; means for formulating an adjusted selling price that may be lower than the highest selling price and within the price range; and means for transmitting the adjusted selling price.

Another aspects of the present invention provides various forms of a method of electronic bargaining for sale of goods. One form of the method of electronic bargaining for sale of goods comprises: receiving, by a server for an electronic bargaining web site, a buyer's desired price of goods posted on the web site; determining whether the buyer's desired price falls within a predetermined price range of the goods, the price range including highest and lowest selling prices thereof; and if the buyer's desired price may be below the lowest selling price, transmitting to the buyer a seller's adjusted price that may be lower than the highest selling price and within the price range.

The seller's adjusted price may be provided by a seller of the goods in reply to the buyer's desired price. The seller's adjusted price may be provided by a seller of the goods prior to the receipt of the buyer's desired price. The seller's adjusted price may be automatically formulated by the server. The server may formulate the seller's adjusted price substantially immediately upon receipt of the buyer's desired price. The method may further comprise receiving, by the server, a buyer's desired quantity along with the buyer's desired price. The seller's adjusted price may be formulated by the server with reference to the buyer's desired quantity. The seller's adjusted price may be formulated such that the seller's adjusted price decreases when the buyer's desired quantity increases. The predetermined price range may be provided by a seller. The method may further comprise receiving from the buyer a buyer's acceptance to the seller's adjusted price. The method may further comprise transmitting to the buyer an acceptance to the buyer's desired price if the buyer's desired price falls within the price range.

The above-described method may further comprise repeating the method with respect to the same buyer. The method may be repeated to a fixed number of times. After the fixed number of repetitions, the method further comprises: formulating a server's proposed sale price based on the price range and the buyer's desired price in each repetition; and transmitting the server's proposed sale price to the buyer for acceptance. The method may further comprise receiving an acceptance of the buyer to the server's proposed sale price. The method may further comprise transmitting the server's proposed sale price to a seller of the goods for acceptance. The method may further comprise receiving an acceptance of the seller to the server's proposed sale price. The proposed sale price may be lower than or equal to the lowest selling price. The proposed sale price may be higher than the lowest selling price.

The above-described method may further comprise receiving from the buyer either a buyer's adjusted price or a buyer's acceptance to the seller adjusted price. The method may further comprise transmitting the buyer's acceptance to the seller upon receipt thereof. The method may further comprise, upon receipt of the buyer's adjusted price, determining whether the buyer's adjusted price falls within the price range including the highest and lowest selling prices. The method may further comprise: in case the buyer's adjusted price falls within the price range, transmitting to the buyer an acceptance to the buyer's adjusted price; and in case the buyer's adjusted price may be below the lowest selling price, transmitting to the buyer seller's another adjusted price that may be lower than the seller's adjusted price and within the price range. If the buyer's desired price falls within the price range, the method may further comprise transmitting a seller's acceptance to the buyer. The seller's acceptance may be substantially immediately transmitted by the server. The method may further comprise receiving a buyer's confirmation to the seller's acceptance. The method may further comprise processing for payment of the accepted price. The method may further comprise transmitting the buyer's confirmation to a seller of the goods.

Another method for electronic bargaining for sale of goods comprises: connecting, by a buyer, to an electronic bargaining web site on a server; locating, by the buyer, goods to buy and a selling price of the goods posted on the web site; transmitting, from the buyer, to the server a buyer's desired price for the goods; receiving, by the buyer, either a seller's acceptance to the buyer's desired price or a seller's adjusted price for further bargaining; and in case of receipt of the seller's adjusted price, transmitting, from the buyer, to the server either a buyer's acceptance to the seller's adjusted price or a buyer's adjusted price for further bargaining. The server may automatically formulate and transmits the seller's acceptance to the buyer when the buyer's desired price may be within a predetermined price range for acceptance. The seller's acceptance may be received by the buyer substantially immediately after the buyer's transmitting the buyer's desired price. The seller's adjusted price may be automatically formulated by the server such that the seller's adjusted price may be higher than the buyer's desired price and within a predetermined price range provided by the seller to the server. The seller's adjusted price may be received by the buyer substantially immediately after the buyer's transmitting the buyer's desired price. The seller's adjusted price may be originated from the seller. The seller may be a person who has registered for electronic bargaining of the goods by providing information about the goods and a price. The server may comprise a plurality of components, one or more of which are located in different locations. The method may further comprise receiving, by the buyer, from the server a server's proposed sale price in case of no acceptance by either the buyer or seller.

Another method for electronic bargaining comprises: causing, by a buyer, to transmit information identifying the buyer's desired goods to a server for an electronic bargaining web site, wherein at least part of the information for identifying the buyer's desired goods may be posted on the electronic bargaining web site; receiving, by the buyer, a seller's desired price for selling the goods by a seller, wherein the buyer receives the seller's desired price through the web site; transmitting, from the buyer, to the server either a buyer's acceptance to the seller's desired price or a buyer's adjusted buying price; and receiving, by the buyer, either a seller's acceptance to the buyer's adjusted buying price or a seller's adjusted price. The method may further comprise transmitting, from the buyer, to the server a buyer's price range for accepting a seller's desired price falling within the price range. The method may further comprise transmitting, from the buyer, to the server a quantity of the goods that the buyer desires to buy. The seller may be a person connecting to the server of the electronic bargaining web site and participating in the electronic bargaining to sell the buyer's desired goods to the buyer. The buyer may cause to transmit the information from another web site posting the buyer's desired goods. The transmission of the information may comprise running a software configured to retrieve information from a web site and to initiate transmission of at least part of the retrieved information to the electronic bargaining web site. The other web site may further disclose a price for the buyer's desired goods. The method may further comprise transmitting, from the buyer or the server of the electronic bargaining web site, to a server of the other web site a notice that the buyer's desired goods are posted for bargaining at the electronic bargaining web site. The method may further comprise transmitting, from the buyer or the server of the electronic bargaining web site, to a person who posted the buyer's desired goods on the other web site a notice that the buyer's desired goods are posted for bargaining at the electronic bargaining web site. The server may comprise a plurality of components, one or more of which are located in different locations.

Another method for electronic bargaining for sale of goods comprises: connecting, by a seller, to an electronic bargaining web site on a server; transmitting, by the seller, to the server information for registering for an electronic sale of goods, wherein the information comprises identification of the goods and a seller's desired price for the goods, wherein at least part of the information may be posted on the electronic bargaining web site; receiving, by the seller, a buyer's desired price; and transmitting, from the seller, to the server either a seller's adjusted price for further bargaining or a seller's acceptance to the buyer's desired price. The buyer may be a person connecting to the electronic bargaining web site and participating in the electronic bargaining to buy the goods from the seller. The server may comprise a plurality of components, one or more of which are located in different locations. The method may further comprise receiving, by the seller, either a buyer's adjusted price for further bargaining or a buyer's acceptance to the seller's adjusted price. The method may further comprise receiving, by the seller, a server's proposed sale price in case of no acceptance by either the buyer or seller. The method may further comprise receiving, by the seller, a buyer's acceptance to the server's proposed sale price. The method may further comprise transmitting, from the seller, a seller's acceptance to the server's proposed sale price. The method may further comprise transmitting, from the seller, to the server either seller's another adjusted price for further bargaining or a seller's acceptance to the buyer's adjusted price. The method may further comprise receiving by the seller from the server either buyer's another adjusted price or a buyer's acceptance to the seller's other adjusted price. The information may further comprise a quantity of the goods for sale.

Another method for an electronic sale of goods comprises: connecting, by a seller, to an electronic bargaining web site on a server; transmitting, from the seller, to the server information for registering for an electronic sale of goods, wherein the information comprises identification of goods for sale and a price range for electronic bargaining, wherein at least part of the information may be to be posted on the electronic bargaining web site; and receiving, by the seller, from the server an acceptance by a buyer to a price, which may be formulated by the server with use of the price range and a price proposed by the buyer. The server-formulated price may be within the price range transmitted by the seller. The server formulated price may be below the lower limit of the price range. The method may further comprise transmitting, by the seller, to the server a seller's acceptance to the server formulated price. The buyer may be a person connecting to the electronic bargaining web site and participating in the electronic bargaining to buy the goods. The server may comprise a plurality of components, one or more of which are located in different locations.

An aspect of the present invention is to provide a system and method which is capable of providing reasonable electronic commerce in accordance with a variety of opinions and conditions between sellers and purchasers by deciding trade prices through 1 to 1 price negotiations between first clients who register goods to be sold or purchased on a network and second clients who wish to participate in the price negotiations for the registered goods.

Another aspect of the present invention is to provide a system and method which is capable of attracting a greater number of users by selecting goods to be sold or purchased through goods search or Internet shopping mall surfing by a price comparison service server and then registering the selected goods more easily.

The present invention provides an electronic commerce system for negotiating a price on a network, comprising a negotiation management server for operating an electronic shopping mall which is connected to first and second clients through a network and in which a trade price is decided by 1 to 1 price negotiations between the first and second clients, and controlling a series of functions for the 1 to 1 price negotiations between the first and second clients; a price negotiation engine controlled by the negotiation management server and including a registration module for receiving and registering data on goods to be sold or purchased and data on a negotiation environment inputted from the first clients, a negotiation progress module for selecting any of the second clients which wishes to participate in the price negotiations and then displaying a negotiation window through which negotiation data proposing the quantity and price of the goods in the price negotiations are inputted so that the price negotiations between the first and second clients is progressed, and a calculation module for receiving the negotiation data proposing the quantity and price of the goods from the first and second clients through the negotiation window, calculating a fair negotiation unit price based on the received negotiation data and the negotiation environment data, and calculating and outputting the degree of negotiation intention as the degree of access to the price negotiations by comparing and analyzing the fair negotiation unit price and the negotiation data; and a database server controlled by the negotiation management server for storing member information on the first and second clients subscribing as members, registered goods information on the goods data and the negotiation environment data of the registered goods to be sold or purchased from the first clients, and negotiation management information on negotiation history, trade details and approval details in the price negotiations between the first and second clients.

In addition, the present invention provides an electronic commerce method for deciding a trade price through price negotiations between first and second clients connected via a network in an electronic commerce system, comprising a member authentication step of confirming members when the first and second clients are connected via the network; after the member authentication step, when goods data for goods to be sold and purchased and negotiation environment data as negotiation materials are inputted from the first clients, a registration step of registering the inputted goods data and negotiation environment data as trade goods into a database server; after the registration step, when the second clients select the registered goods in order to participate in the price negotiations, a display step of displaying a negotiation window for allowing the first and second clients to input negotiation data proposing the quantity and price of the goods; after the display step, when the negotiation data proposing the quantity and price of the goods are inputted from the first and second clients, a price negotiation step of calculating a fair agreement unit price based the inputted negotiation data and the negotiation environment data, comparing and analyzing the calculated fair agreement unit price and the negotiation data, and displaying the degree of negotiation intention as the degree of access to the price negotiations; after the price negotiation step, a negotiation progress determination step of, when it is confirmed that the negotiation data proposed by the other party are accepted by the first or second clients, deciding a trade price based on the accepted negotiation data and then ending the price negotiations, and when it is confirmed that the negotiation data proposed by the other party are not accepted by the first or second clients, confirming a predetermined negotiation term or the number of proposals of the negotiation data and determining whether the price negotiations is further progressed or not; after the negotiation progress determination step, when it is confirmed that the trade price is not decided for the ended price negotiations, a price negotiation arbitration step of proposing a fair agreement arbitration condition for the quantity and price of the goods generated based on price negotiation history and negotiation environment data to the first and second clients and acquiring a confirmation as to whether the agreement arbitration condition is accepted or not by the first and second clients; and when the trade price is decided for the price negotiations ended after the negotiation progress determination step, or when the proposed agreement arbitration condition is accepted by the first and second clients after the price negotiation arbitration step, a trade accomplishment step of confirming the decided trade price or the trade details and the approval details for the agreement arbitration conditions and then registering them into the database server.

### BRIEF DESCRIPTION OF THE DRAWINGS

FIG. 1 is a view showing a configuration of an electronic commerce system for negotiating a price on a network, to which the present invention is applied;

FIG. 2 is a flowchart illustrating an electronic commerce method for negotiating a price on a network according to an embodiment of the present invention;

FIGS. 3a and 3b are views showing goods registration screens for inputting data on goods and data on a negotiation environment from first clients according to the present invention;

FIG. 4 is a detailed flowchart illustrating a registration step in a registration method through a goods search of a price comparison service server which can be further employed in the embodiment shown in FIG. 2;

FIG. 5 is a detailed flowchart illustrating a registration step in a registration method through a web browser plug-in application which can be further employed in the embodiment shown in FIG. 2;

FIG. 6 is a view showing a screen configuration of a price negotiation window through which the price negotiations between first and second clients are progressed in FIG. 2;

FIG. 7 is a detailed flowchart illustrating a price negotiation step in 1 to 1 price negotiations between the first and second clients which can be further employed in the embodiment shown in FIG. 2;

FIG. 8 is a detailed flowchart illustrating a price negotiation step of automatically calculating and proposing data on negotiations of the first clients which can be further employed in the embodiment shown in FIG. 2; and

FIG. 9 is a detailed flowchart illustrating a negotiation progress determination step and a price negotiation arbitration step which can be further employed in the embodiment shown in FIG. 2.

### DESCRIPTION OF PREFERRED EMBODIMENTS

Hereinafter, an electronic commerce system and method for negotiating a price on a network according to the present invention will be described in terms of their embodiments with reference to the accompanying drawings.

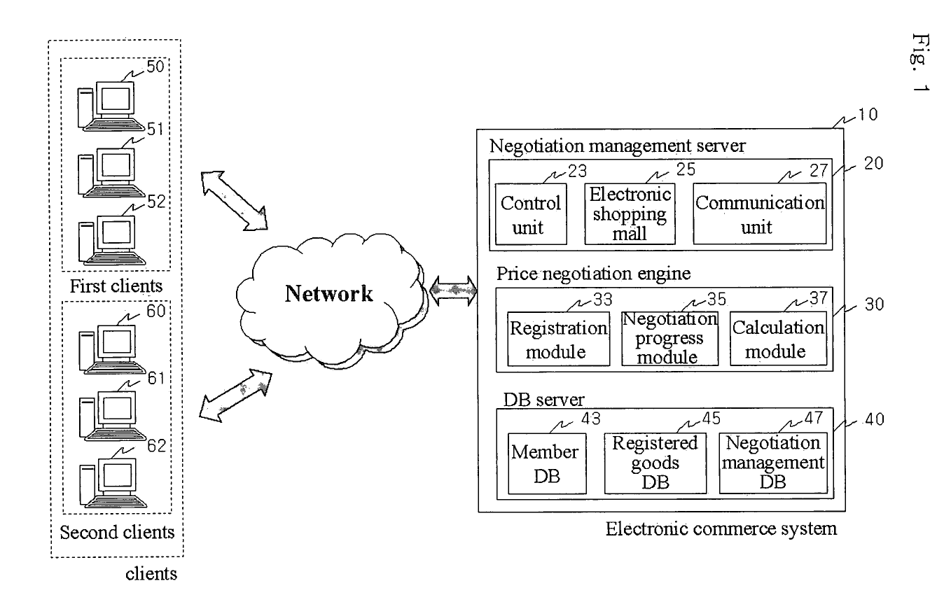

FIG. 1 is a view showing a configuration of an electronic commerce system for negotiating a price on a network, to which the present invention is applied.

Referring to the figure, an electronic commerce system 10 (hereinafter, simply referred to as “system”) of the present invention is connected to first clients 50 to 52 and second clients 60 to 62 through a wiring or wireless network.

In addition, preferably, the system 10 is connected to terminals of approval companies or delivery companies, price comparison service servers, Internet shopping malls, etc., which are not shown in the figure, so that electronic commerce can be smoothly implemented in 1 to 1 price negotiations between the first clients 50 to 52 and second clients 60 to 62 on the network.

Here, the first clients 50 to 52 are network-based terminals of users (members), such as computer systems, PDAs, and Internet TV terminals, connected to the system 10 through the network for registering goods to be sold or purchased.

In addition, the second clients 60 to 62 are network-based terminals of users (members), such as computer systems, PDAs, and Internet TV terminals, connected to the system 10 for participating in price negotiations in order to sell or purchase the registered goods.

Since hardware, software and networking means for implementing the first clients 50 to 52 and second clients 60 to 62 are well known to those skilled in the art, detailed descriptions thereof will be omitted.

The system 10 includes a negotiation management server 20, a price negotiation engine 30 and a database server 40.

The negotiation management server 20 includes a control unit 23, an electronic shopping mall 25 and a communication unit 27.

Here, the control unit 23 includes an operation system (OS) for controlling operations of the system 10, hardware drivers, applications required by the system 100 and the like, for controlling a series of functions for performing the electronic commerce for the 1 to 1 price negotiations between the first clients 50 to 52 and second clients 60 to 62 on the network.

In addition, the electronic shopping mall 25 as a web site for providing a world wide web service or a mobile site allowing a mobile Internet provides an environment for the electronic commerce including member registration, goods registration, selling and purchasing of goods through the 1 to 1 price negotiations, electronic approval, etc.

Meanwhile, the communication unit 27 comprises hardware and network means (for example, adaptors, protocols, etc.) enabling wiring or wireless network communications with the first clients 50 to 52 and second clients 60 to 62 for providing a communication environment on the network.

The price negotiation engine 30 includes a registration module 33, a negotiation progress module 35 and a calculation module 37.

Here, the registration module 33 receives data on goods to be sold or purchased and data on negotiation environment from the first clients 50 to 52 accessing the electronic shopping mall 25 in the negotiation management server 20 and registers the data into the database server 40.

The goods data include a goods kind (for example, electrical appliances, furniture, etc.), a goods name, an open market price for goods, goods specifications, goods presentation, etc., and the negotiation environment data include a registered quantity, a desired highest unit price (highest possible unit price), a desired lowest unit price (lowest possible unit price), a negotiation way, a negotiation term, etc. for the goods data.

In addition, the registration module 33 preferably further includes an automatic registration module and a proxy automatic registration module for supporting a method of performing registration through a goods search of a price comparison service server allowing simple input of the data on goods to be registered by the first clients 50 to 52 and a method of performing registration through plug-in applications for use in a web browser.

Here, the method of performing the registration through the goods search of the price comparison service server is a method in which a goods search window for searching goods of the price comparison service server is displayed on a goods registration screen for inputting the goods data, the first client 50 to 52 search and select goods to be registered through the goods search window, and the automatic registration module of the registration module 33 receives data on the selected goods from the price comparison service server and automatically classifies and inputs the received data for the goods kind, goods name, open market price for goods, goods presentation, etc.

The method of performing the registration through the plug-in applications for use in the web browser is a method in which the plug-in applications for the web browser using proxy technology are provided to the first clients 50 to 52 and installed in their web browser, the first clients 50 to 52 request registration of goods to be sold or purchased by use of the plug-in applications while surfing the Internet shopping mall, and then the proxy automatic registration module of the registration module 33 extracts data on goods requested to be registered from the Internet shopping mall, and automatically classifies and inputs the extracted data on the goods kind, goods name, open market price for goods, goods presentation, etc.

In such ways, since the first clients 50 to 52 can simply input and register the data on goods to be sold or purchased, there is an advantage in that time required for data input can be saved and the goods data can be inputted fairly and abundantly.

In the meantime, when any of the second clients 60 to 62 accessing the electronic shopping mall 25 of the negotiation management server is selected to participate in price negotiations for the registered goods, the negotiation progress module 35 displays the negotiation window through which the second clients 60 to 62 participating in the price negotiations with the first clients 50 to 52 which have registered the goods can input negotiation data, so that the 1 to 1 price negotiations between the first clients 50 to 52 and second clients 60 to 62 can be progressed.

Here, when the negotiation data on the quantity and price of goods are inputted from the first clients 50 to 52 and second clients 60 to 62 to the negotiation progress module 35 through the negotiation window, the negotiation progress module 35 offers a reference material for the progress of price negotiations between the first clients 50 to 52 and second clients 60 to 62 by displaying the degree of negotiation intention of the first clients 50 to 52 and second clients 60 to 62.

The degree of negotiation intention is referred to as information on the degree of access to the price negotiations defined by comparison and analysis between the negotiation data proposed by the first clients 50 to 52 and second clients 60 to 62 and a fair agreement unit price calculated by the calculation module 37. For example, this may be classified into 5 levels (very negative, negative, ordinary, positive, very positive): level 1 representing a proposal condition (negotiation data) farthest from the fair agreement unit price and level 5 representing a proposal condition (negotiation data) nearest from the fair agreement unit price. Such degree of negotiation intention is to be provided for approaching a negotiation agreement point when the first clients 50 to 52 and second clients 60 to 62 input desired negotiation data after confirming degrees of negotiation intention of themselves and the other party.

More preferably, the negotiation progress module 35 imposes a limitation (for example, proposal allowed up to 3 times) on the number of proposals of negotiation data to the other party by the first and second clients in order to prevent possible tiresome price negotiations, minimize time consumption and maximize a negotiation effect.

Furthermore, when the price negotiations is ended without deciding a trade price due to expiration of preset negotiation term, limitation on proposal of negotiation data and so on in the price negotiations between the first clients 50 to 52 and second clients 60 to 62, the negotiation progress module 35 preferably generates a fair agreement arbitration condition for the quantity and price of goods based on price negotiation history and negotiation environment data, suggests the generated fair agreement arbitration condition to the first clients 50 to 52 and second clients 60 to 62, inquires whether the suggested fair agreement arbitration condition is accepted or not, and acquires a result of the inquiry.

In addition, if a negotiation way is selected as “automatic” in negotiation environment data on the registered goods and negotiation data proposing the quantity and price of goods are inputted from the second clients 60 to 62 participating in the price negotiations, the negotiation progress module 35 preferably further includes an automatic negotiation module for displaying the inputted negotiation data and the degree of negotiation intention and automatically generating and displaying negotiation data on the quantity and price of goods corresponding to the degree of negotiation intention of the second clients 60 to 62 in place of the negotiation data proposed by the first clients 50 to 52.

Here, the negotiation data to be displayed automatically is differentially generated by the negotiation data on the quantity and price of goods proposed by the second clients 60 to 62.

For example, assuming that negotiation data A propose 2 in quantity and 20,000 won (Korean currency) in unit price and negotiation data B propose 5 in quantity and 20,000 won in unit price, when the negotiation data A are received from the second clients 60 to 62, the automatic negotiation module confirms the degree of negotiation intention of the negotiation data A and generates automatic negotiation data (for example, 2 in quantity and 26,000 won in unit price) corresponding to the confirmed degree of negotiation intention.

In addition, when the negotiation data B are received from the second clients 60 to 62, the automatic negotiation module confirms the degree of negotiation intention of the negotiation data B and generates automatic negotiation data (for example, 5 in quantity and 23,500 won in unit price) corresponding to the confirmed degree of negotiation intention.

Namely, when the unit price of the registered goods to be sold is equal to an unit price proposed by the second clients 60 to 62 which wish to purchase the registered goods, a larger quantity of goods yields a lower fair agreement unit price resulting in a higher degree of negotiation intention. Therefore, the unit price of the negotiation data displayed by the automatic negotiation module corresponding to the higher degree of negotiation intention is proposed as a unit price with a more discount.

In addition, when the negotiation data proposed to the second clients 60 to 62 by the automatic negotiation module are accepted by the second clients 60 to 62, the accepted negotiation data are transmitted to the first clients 50 to 52 through an E-mail or a text message to confirm as to whether the negotiation data are accepted or not.

Therefore, since the automatic negotiation module of the negotiation progress module 35 instead of the first clients 50 to 52 executes the price negotiations for the goods to be sold or purchased which the first clients 50 to 52 have registered, time required for the price negotiations can be reduced and it is possible for users who are not accustomed to price negotiations to perform the electronic commerce with reasonable price negotiations.

In addition, the negotiation progress module 35 is configured to perform more effective price negotiations by sequentially displaying the negotiation data of the first clients 50 to 52 and second clients 60 to 62 or simultaneously displaying the inputted negotiation data of the first clients 50 to 52 and second clients 60 to 62 in real time.

Meanwhile, when the negotiation data proposing the quantity and price of goods are received from the first clients 50 to 52 and second clients 60 to 62 through the negotiation progress module 35, the calculation module 37 calculates a fair negotiation unit price for the quantity of goods of the received negotiation data based on the desired highest unit price, the desired lowest unit price of the negotiation environment data, etc.

In addition, the calculation module 37 calculates degrees of negotiation intention of the first clients 50 to 52 and second clients 60 to 62 representing degrees of access to the price negotiations by comparing and analyzing the calculated fair negotiation unit price and the negotiation data, and then displays the calculated degrees of negotiation intention through the negotiation progress module 35.

For example, assume that the first clients 50 to 52 register negotiation environment data in order to sell goods as follows:

Registered quantity of goods: 50 pieces

Desired highest unit price (starting price): 30,000 won

Desired lowest unit price: 23,000 won

Desired unit price when the entire registered quantity of goods is purchased (option): 20,000 won

Other information (negotiation term, negotiation way, approval way, etc.): *****

Here, if the second clients 60 to 62, which wish to participate in the price negotiations, input 2 pieces in purchase quantity and 21,00 won in unit price for the registered goods for the proposal of the price negotiations, a fair agreement unit price (for example, 28,000 won) for the inputted 2 pieces is calculated based on the negotiation environment data (the registered quantity of goods, the desired highest unit price, the desired lowest unit price, the desired unit price when the entire registered quantity of goods is purchased, and the like), the degree of access of the calculated fair agreement unit price (28,000 won) is classified into 5 levels, and the degree of negotiation intention (for example, level 1) as the degree of access to the price negotiations for the inputted unit price (21,000 won) is calculated and displayed.

However, if the second clients 60 to 62, which wish to participate in the price negotiations, input 5 pieces in purchase quantity and 21,000 won in unit price for the registered goods for the proposal of the price negotiations, a fair agreement unit price (for example, 25,000 won) for the inputted 5 pieces is calculated based on the negotiation environment data, the calculated fair agreement unit price and the negotiation data (5 pieces, 21,000 won) are compared and analyzed, and the degree of negotiation intention (for example, level 3) for the negotiation data is calculated and displayed.

Namely, when the unit price of the registered goods to be sold is equal to a unit price proposed by the second clients 60 to 62 which wish to purchase the registered goods, a larger quantity of goods to be purchased yields a lower fair agreement unit price. Accordingly, a higher degree of negotiation intention is generated since the degree of access between the proposed unit price and the fair agreement unit price is increased.

On the contrary, when the unit price of the registered goods to be purchased is equal to a unit price proposed by the first clients 50 to 52 which wish to sell the registered goods, a larger quantity of goods to be sold yields a lower fair agreement unit price. Accordingly, a lower degree of negotiation intention is generated since the degree of access between the proposed unit price and the fair agreement unit price is decreased.

Therefore, by calculating the degree of negotiation intention for the negotiation data through proper comparison and analysis based on the negotiation environment data and providing the calculated degree of negotiation intention to the first clients 50 to 52 and second clients 60 to 62, the first clients 50 to 52 and second clients 60 to 62 can approach an agreement point of the price negotiations.

In addition, when the fair agreement unit price is calculated, other items, such as the quantity and price of goods as well as goods delivery term, quality guaranteed term, returns conditions, payment means, package level and the number of the recommended, can be reflected and calculated. In this case, such items should be included in the negotiation environment data and the negotiation data.

In addition, the negotiation environment data include discount information based on other items such as goods delivery term, quality guaranteed term, returns conditions, payment means, package level and the number of the recommended.

At this time, after completing the price negotiations, an advertise-purposed E-mail is forwarded to the recommended with E-mail information of the recommended.

In addition, the advertise-purposed E-mail is preferably configured to allow a direct purchase and approval or a direct participation in the price negotiations without any log-in.

Therefore, over the conventional electronic commerce providing only uniform trade price, delivery, package, or other items, the present invention can contribute in providing more effective and activated electronic commerce by converging a variety of opinions between sellers and purchasers and accordingly forming a reasonable price.

In addition, when a negotiation way is selected as ‘automatic’ in the negotiation environment data of the registered goods, the calculation module 37 calculates the negotiation data for the quantity and price of goods and so on corresponding to the degree of negotiation intention of the second clients 60 to 62 instead of the negotiation data proposed by the first clients 50 to 52 and outputs the calculated negotiation data to the automatic negotiation module of the negotiation progress module 35.

In addition, when generation of an agreement arbitration condition is requested from the negotiation progress module 35 upon ending the price negotiations without deciding a trade price, the calculation module 37 is configured to calculate a fair agreement arbitration condition for the quantity and price of goods and so on based on price negotiation history and negotiation environment data and to output the calculated fair agreement arbitration condition to the negotiation progress module 35.

The database server 40 includes a member database 43, a registered goods database 45 and a negotiation management database 47.

Here, the member database 43 consists of member basic data and member trade data.

The member basic data include IDs, passwords, basic personalities (sex, name, age, E-mail address, where to make contact, etc.) and the like which are received through member subscription from the first clients 50 to 52 and second clients 60 to 62.

The member trade data include progress situations, trade details, approval details, credit levels, electronic signatures, etc. of members for the price negotiations between the first clients 50 to 52 and second clients 60 to 62.

In addition, the registered goods database 45 consists of goods data and negotiation environment data.

The goods data include the goods kind, goods name, market price, goods presentation, etc. of the registered goods to be sold or purchased from the first clients 50 to 52.

The negotiation environment data include a registration quantity, a desired highest unit price, a desired lowest unit price, a negotiation way, a negotiation term, etc. of goods to be sold or purchased from the first clients 50 to 52.

On the other hand, the negotiation management database 47 include history for each negotiations, price negotiation results, and trade details, approval details and delivery details according to the price negotiations results in 1 to 1 price negotiations between the first clients 50 to 52 and second clients 60 to 62.

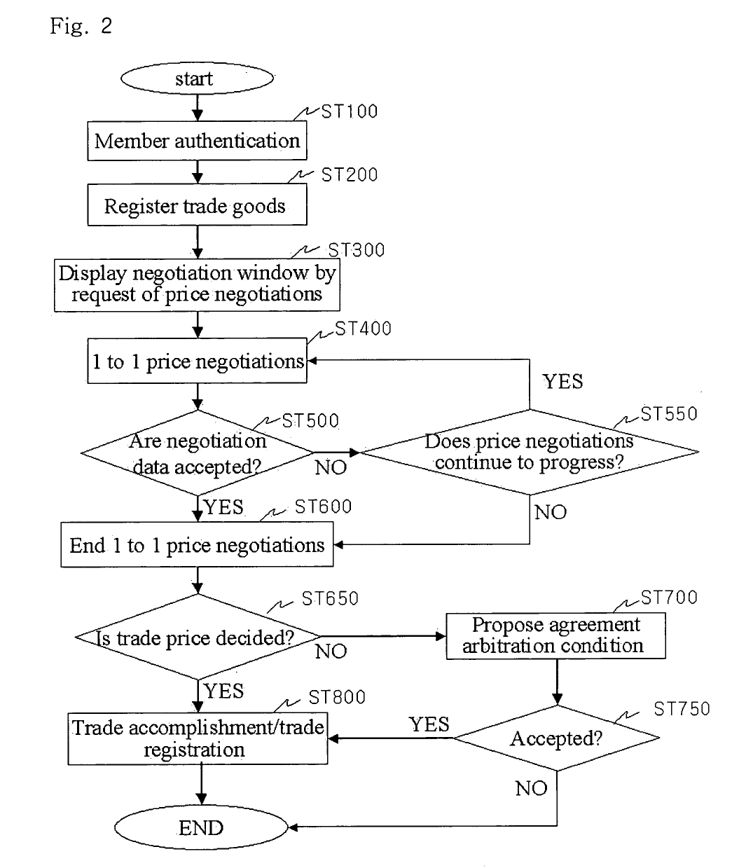

FIG. 2 is a flowchart illustrating an electronic commerce method for negotiating a price on a network according to an embodiment of the present invention.

This procedure is a program incorporated into the system 10 and processed by the negotiation management server 20, the price negotiation engine 30 and the database server 40 in response to the operation of the first clients 50 to 52 and second clients 60 to 62.

Referring to FIG. 2, in the electronic commerce method for deciding a trade price through the 1 to 1 price negotiations between the first clients 50 to 52 and second clients 60 to 62 in the electronic commerce system, when the first clients 50 to 52 and second clients 60 to 62 are connected to each other through a network, a member authentication step of confirming as to whether they are members is performed (ST100).

After the member authentication step ST100, when the data on goods to be sold or purchased and the negotiation environment data as negotiation materials are inputted from the first clients 50 to 52, the inputted goods data and the negotiation environment data are registered as trade goods into the database server 40 (ST200).

Here, in order to allow simpler input of the goods data from the first clients 50 to 52, it is preferable to support an input method through goods search of the price comparison service server and an input method through the plug-in application for use in the web browser.

After the registration step ST200, when the second clients 60 to 62 select the registered goods in order to participate in the price negotiations, a negotiation window for allowing the first clients 50 to 52 and second clients 60 to 62 to input the negotiation data proposing the quantity and price of goods is displayed (ST300).

Here, the negotiation data is information on the quantity, price, etc. of goods to be sold or purchased, which are proposed mutually by the first clients 50 to 52 and second clients 60 to 62. When the negotiation data of the other party are accepted, a trade is accomplished based on the accepted negotiation data.

After the display step ST300, when the negotiation data proposing the quantity and price of goods from one party to the other party of the first clients 50 to 52 and second clients 60 to 62 are inputted, a fair agreement unit price is calculated based on the inputted negotiation data and the negotiation environment data, the calculated fair agreement unit price and the negotiation data are compared and analyzed, and the degree of negotiation intention as the degree of access to the price negotiations is displayed (ST400).

Here, since the degree of negotiation intention is provided to the first clients 50 to 52 and second clients 60 to 62, the first clients 50 to 52 and second clients 60 to 62 can input the negotiation data with reference to the displayed degree of negotiation intention, allowing easier approach to an agreement point in the 1 to 1 price negotiations.

After the price negotiation step ST400, when the one party of the first clients 50 to 52 and second clients 60 to 62 confirms and accepts the negotiation data proposed by the other party (ST500), a trade price is decided based on the accepted negotiation data and then the 1 to 1 price negotiations is ended (ST600). If the negotiation data proposed by the other party are not accepted, it is determined whether the price negotiations is further progressed or not by confirming a predetermined negotiation term or the limited number of proposals of the negotiation data (ST550).

Here, through the determination of the further progress of the price negotiations by the confirmation of the predetermined negotiation term or the limited number (for example, up to 3 times) of proposal of the negotiation data, tiresome price negotiations can be prevented and time consumption can be minimized, resulting in maximized negotiation effect.

After the negotiation progress determination steps ST 500 and ST550, it is confirmed as to whether the trade price is decided or not for the ended price negotiations (ST650). If it is confirmed that the trade price is not decided, a fair agreement arbitration condition for the quantity and price of goods generated based on the price negotiation history and the negotiation environment data is proposed to the first clients 50 to 52 and second clients 60 to 62 (ST700) and it is determined whether the agreement arbitration condition is accepted or not (ST750).

Here, the agreement arbitration condition proposed to the first clients 50 to 52 and second clients 60 to 62 is a condition of fair quantity, price and the like calculated by the price negotiation engine 30 by using the price negotiation history and the negotiation environment data for the purpose of providing a systemic process method of deriving an agreement point in the price negotiations.

When the trade price is decided for the price negotiations ended after the negotiation progress determination steps ST 500 and ST550, or when the proposed agreement arbitration condition is accepted by the first clients 50 to 52 and second clients 60 to 62 after the price negotiation arbitration steps ST700 and ST750, the decided trade price or the trade details and the approval details for the agreement arbitration conditions are confirmed and then registered into the database server 40 (ST800).

Here, the confirmation of the approval details in the trade accomplishment step ST800 preferably further includes a signature confirmation step of registering electronic signature data for members inputted at the time of member registration from the first clients 50 to 52 and second clients 60 to 62 and identifying a signatory by comparing the registered electronic signature data with an electronic signature received at the time of approval of a credit card for the purpose of security of approval of the credit card.

Accordingly, by deciding the trade price through a convergence of a variety of opinions in the 1 to 1 price negotiations between the first clients 50 to 52 and second clients 60 to 62, a reasonable selling and purchase through the price negotiations can be accomplished resulting in contribution to activation of the electronic commerce.

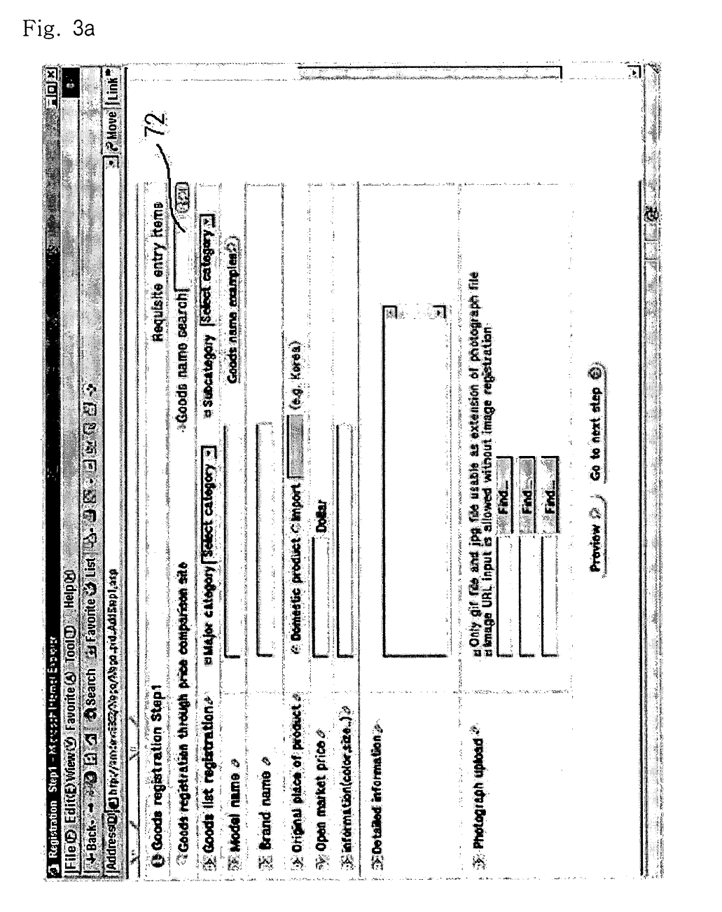

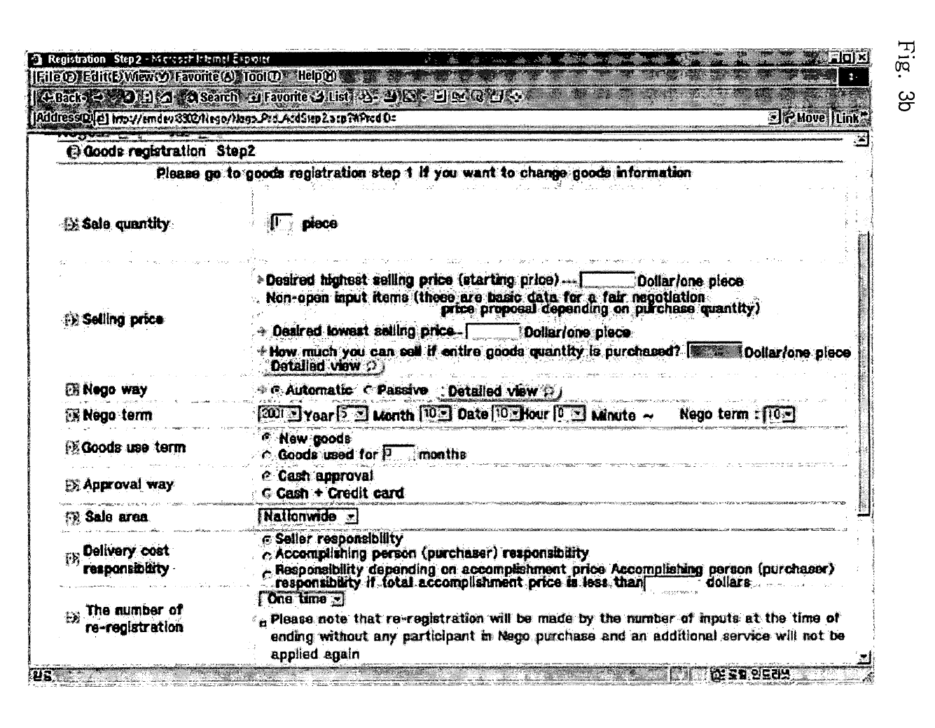

FIGS. 3a and 3b are views showing goods registration screens for inputting data on goods and data on the negotiation environment from first clients according to the present invention.

Referring to FIGS. 3a and 3b, these figures show a goods data input screen (FIG. 3a) and a negotiation environment data input screen (FIG. 3b) for registering goods to be sold or purchased into the system 10 from the first clients 50 to 52.

The goods kind, goods name, market price, goods presentation, etc. of goods to be registered are inputted from the first clients 50 to 52 through the goods data input screen (FIG. 3a).

Here, in order to allow simpler input of the goods data through the goods data input screen (FIG. 3a), it is preferable to support an input method 72 through goods search of the price comparison service server and an input method through the plug-in application for use in the web browser, so that time required for goods data input can be saved and fair and abundant goods data can be inputted even with insufficient information on goods.

The registration quantity, desired highest unit price, desired lowest unit price, negotiation way, negotiation term, etc. of goods are inputted from the first clients 50 to 52 through the negotiation environment data input screen (FIG. 3b).

Here, the negotiation environment data input screen is opened with the desired highest unit price as a starting unit price in the price negotiations when the registered goods are goods to be sold and with desired lowest unit price as a starting unit price in the price negotiations when the registered goods are goods to be purchased.

In addition, when the negotiation data include not only the quantity and price of goods but also goods delivery terms, quality guaranteed terms, returns conditions, payment means, package levels, the number of the recommended, etc. for the price negotiations, it is preferable to further include relevant discount information in the negotiation environment data.

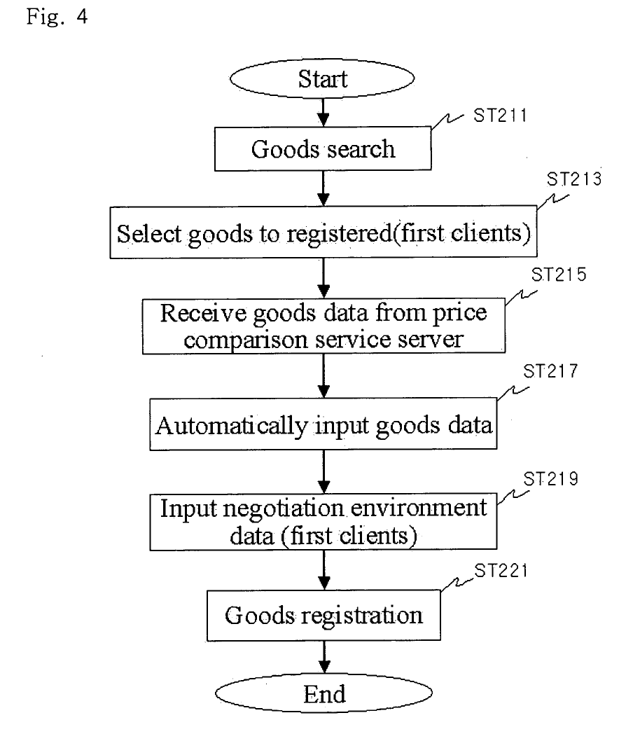

FIG. 4 is a detailed flowchart illustrating a registration step in a registration method through a goods search of the price comparison service server which can be further employed in the embodiment shown in FIG. 2.

Here, the system 10 is connected to the price comparison service server through the network for selecting the registered goods through the goods search provided by the price comparison service server.

Referring to FIG. 4, the registered goods are searched (ST211) and selected (ST213) through the goods search window (72 in FIG. 3a) of the goods registration screen from the first clients 50 to 52.

After the registered goods are selected from the first clients 50 to 52 (ST213), the goods data on the selected goods are received from the price comparison service server (ST215), classified into the goods kind, goods name, market price, goods presentation, etc., and then automatically inputted to the goods registration screen (ST217).

In addition, the negotiation environment data including the registration quantity, desired highest unit price, desired lowest unit price, negotiation way, negotiation term, etc. of goods as basic materials for the negotiation progress are inputted from the first clients 50 to 52 through the goods registration screen (ST219) and then registered into the database server 40 (ST221).

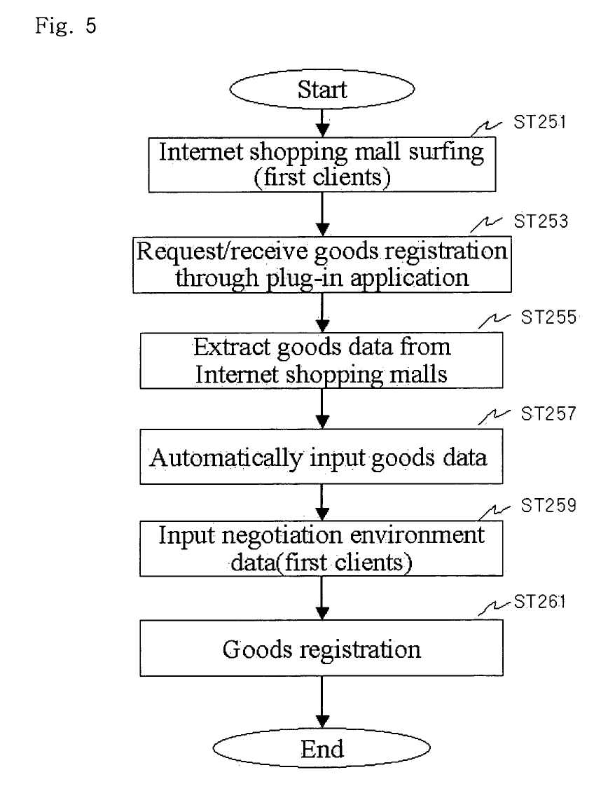

FIG. 5 is a detailed flowchart illustrating a registration step in a registration method through a web browser plug-in application which can be further employed in the embodiment shown in FIG. 2.

Here, the system 10 provides plug-in applications for use in a web browser using a proxy technology to the first clients 50 to 52.

Referring to FIG. 5, while the first clients 50 to 52 in which the provided applications have been installed on their web browsers surf the Internet shopping mall through the web browsers (ST251), goods to be sold or purchased are confirmed and registration of goods is requested by using the plug-in applications (ST253).

Next, goods data are extracted from the Internet shopping mall having goods data of the requested goods (ST255), and classified into the goods kind, goods name, market price, goods presentation, etc. and then automatically inputted to the goods registration screen.

In addition, the negotiation environment data including the registration quantity, desired highest unit price, desired lowest unit price, negotiation way, negotiation term, etc. of goods as basic materials for the negotiation progress are inputted from the first clients 50 to 52 through the goods registration screen (ST259) and then registered into the database server 40 (ST261).

In addition, after the goods registration step ST261, the system 10 preferably further includes a goods registration notification step of forwarding E-mails telling the goods registration completion to the Internet shopping mall so that the persons concerned in the Internet shopping mall can participate in the price negotiations.

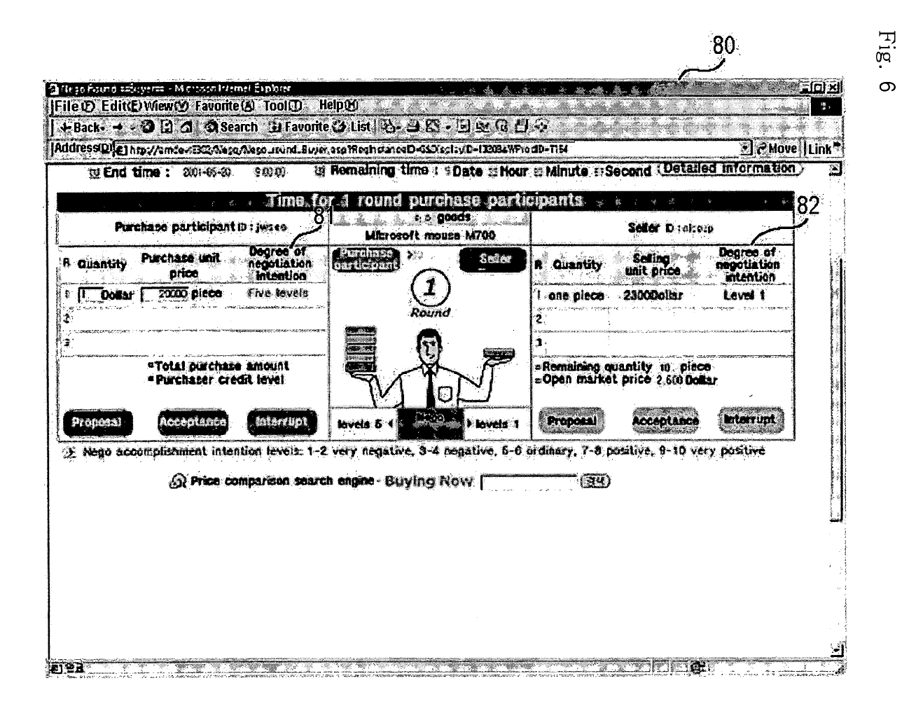

FIG. 6 is a view showing a screen configuration of a price negotiation window through which the price negotiations between first and second clients is progressed in FIG. 2.

When the registered goods are selected by the second clients 60 to 62 which wish to participate in the price negotiations, the system 10 displays a negotiation window 80 for inputting the negotiation data from the first clients 50 to 52 which have registered the goods and the second clients 60 to 62.

Referring to FIG. 6, the quantity and unit price of goods are inputted from the first clients 50 to 52 and second clients 60 to 62 and then the degree of negotiation intention 81 is displayed.

In addition, the price negotiation window 80 provides an environment for the 1 to 1 price negotiations between the first clients 50 to 52 and second clients 60 to 62 by providing interfaces 83 for use in suggestions of the price negotiations, acceptance for the negotiation data of the other party, interruption requests for the price negotiations, etc.

In addition, the negotiation window 80 can be configured to sequentially display the negotiation data of the first clients 50 to 52 and second clients 60 to 62 or simultaneously display the negotiation data of the first clients 50 to 52 and second clients 60 to 62.

More preferably, the number of proposals of the negotiation data is limited to prevent tiresome price negotiations.

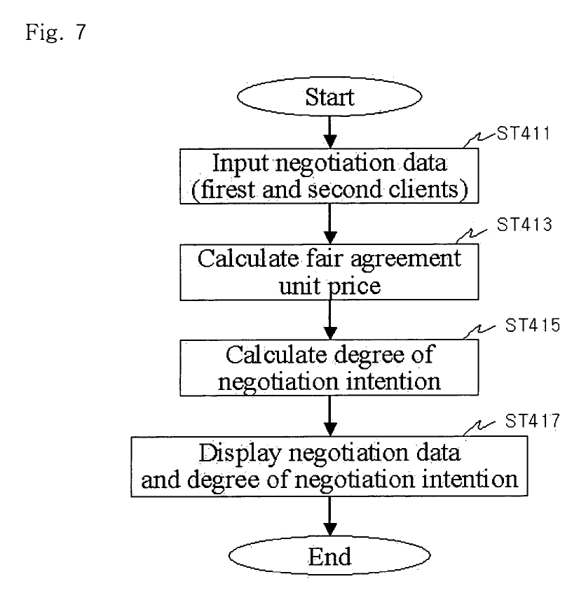

FIG. 7 is a detailed flowchart illustrating a price negotiation step in 1 to 1 price negotiations between first and second clients which can be further employed in the embodiment shown in FIG. 2.

Referring to FIG. 7, when the negotiation data proposing the quantity and price of goods to the other party from the first clients 50 to 52 and second clients 60 to 62 are inputted (ST411), a fair agreement unit price is calculated based on the inputted negotiation data and the negotiation environment data (ST413).

Next, the calculated fair agreement unit price and the negotiation data are compared and analyzed, the degree of negotiation intention as the degree of access to the price negotiations is calculated (ST415), and the negotiation data and the degree of negotiation intention are displayed through the negotiation window 90 (ST417).

Here, when the first clients 50 to 52 and second clients 60 to 62 accept the negotiation data proposed by the other party, a trade price is decided based on the accepted negotiation data and the 1 to 1 price negotiations is ended.

In addition, when the negotiation data proposed by the other party are not accepted, it is determined whether the 1 to 1 price negotiations between the first clients 50 to 52 and second clients 60 to 62 is further progressed or not by confirming a predetermined negotiation term or the limited number of proposals of the negotiation data.

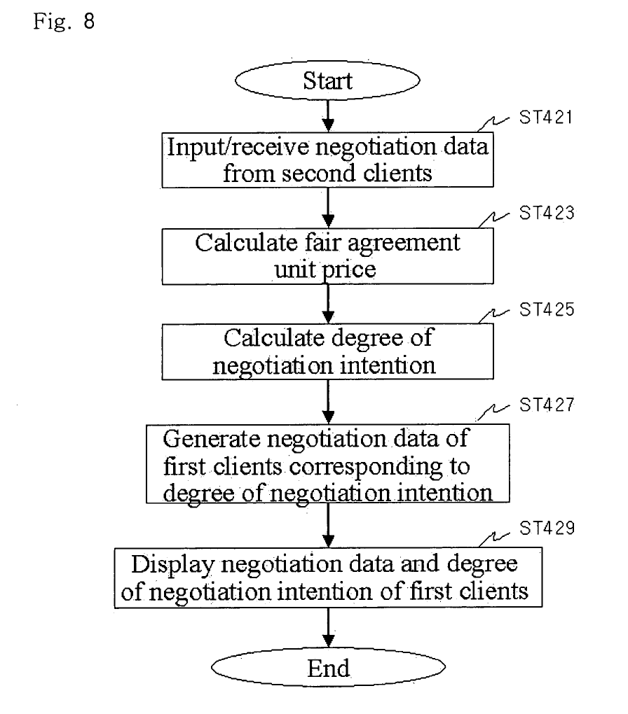

FIG. 8 is a detailed flowchart illustrating a price negotiation step of automatically calculating and proposing data on negotiations of the first clients which can be further employed in the embodiment shown in FIG. 2.

If a negotiation way is registered as ‘automatic’ in the negotiation environment data of the registered goods, the system 10 outputs the negotiation data instead of the first clients 50 to 52 which have registered the goods and executes the price negotiations with the second clients 60 to 62 which have participated in the price negotiations.

Referring to FIG. 8, when the negotiation data are inputted from the second clients 60 to 62 which have participated in the price negotiations (ST421), a fair agreement unit price is calculated based on the inputted negotiation data and the negotiation environment data (ST423).

Next, the calculated fair agreement unit price and the negotiation data are compared and analyzed, the degree of negotiation intention of the second clients 60 to 62 as the degree of access to the price negotiations is calculated (ST425), and the negotiation data and the degree of negotiation intention of the second clients 60 to 62 are displayed through the negotiation window 90 (ST417).

In addition, the negotiation data corresponding to the degree of negotiation intention of the second clients 60 to 62 are generated (ST427), the generated negotiation data and the corresponding degree of negotiation intention are automatically displayed through the negotiation window 80 (ST429), and the system 10 executes the price negotiations with the second clients 60 to 62 on behalf of the first clients 50 to 52.

In this case, when the generated negotiation data are accepted by the second clients 60 to 62, the system 10 preferably further includes a step of acquiring a confirmation as to whether the accepted negotiation data is accepted or not from the first clients 50 to 52 through an E-mail or text message.

Namely, the system 10 forwards the E-mail or text message telling the negotiation data accepted by the second clients 60 to 62 to the first clients 50 to 52 and acquires a confirmation as to whether the negotiation data accepted by the second clients 60 to 62 are accepted or not by the first clients 50 to 52 through a reply function of the E-mail or text message from the first clients 50 to 52.

As described above, since the system 10 on behalf of the first clients 50 to 52 executes the price negotiations for the registered goods to be sold or purchased by the first clients 50 to 52, time required for the price negotiations can be saved and it is possible for users who are not accustomed to the price negotiations to perform the electronic commerce for reasonable price negotiations.

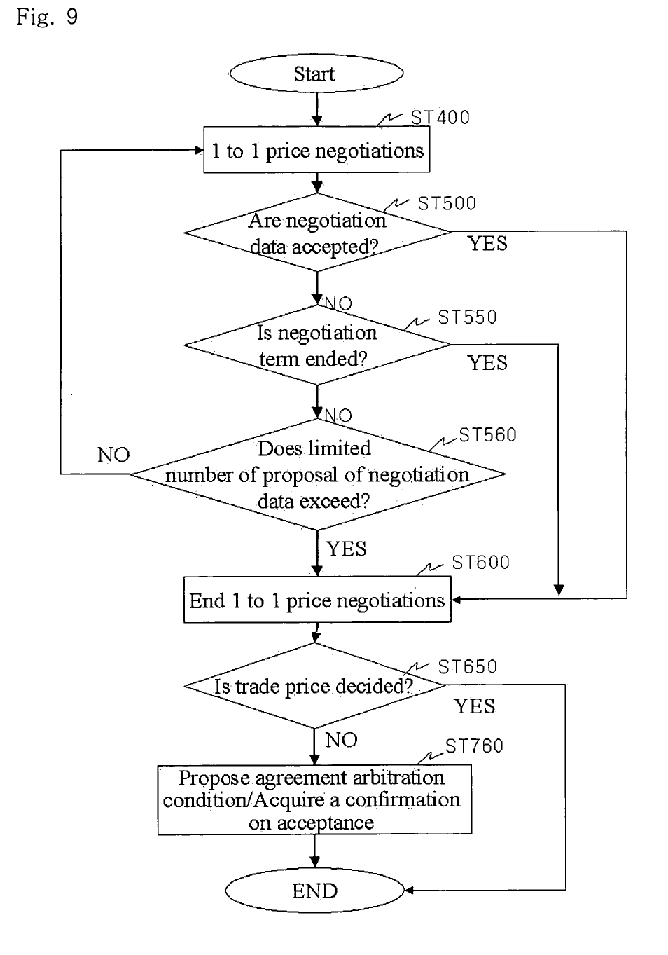

FIG. 9 is a detailed flowchart illustrating a negotiation progress determination step and a price negotiation arbitration step which can be further employed in the embodiment shown in FIG. 2

Referring to FIG. 9, after the price negotiation step ST400, it is determined whether the negotiation data proposed by the other party are accepted or not by the first clients 50 to 52 and second clients 60 to 62 (ST500). If the negotiation data are accepted, a trade price is decided based on the accepted negotiation data and the price negotiations is ended (ST600).

However, if the negotiation data are not accepted, it is determined whether a predetermined negotiation term is ended or not (ST550). If it is determined that the predetermined negotiation term (closing time) based on the negotiation environment data is ended, the price negotiations is ended (ST600). If the negotiation term is not ended, the number of proposals of the negotiation data by the first and second clients is confirmed (ST560).

If it is confirmed that the number of proposals of the negotiation data reaches a limited number, the price negotiations is ended (ST600). Otherwise, the price negotiation step continues to be performed.

Next, it is confirmed whether a trade price is decided or not for the ended price negotiations (ST650). If it is confirmed that the trade price is not decided, a fair agreement arbitration condition for the quantity and price of goods is generated based on the price negotiation history and the negotiation environment data and suggested to the first and second clients in order to obtain a confirmation as to whether the fair agreement arbitration condition is accepted or not.

Here, if the price negotiations of the first clients 50 to 52 is set to ‘automatic’, the fair agreement arbitration condition is forwarded to the first clients 50 to 52 through the E-mail and text message and it is confirmed as to whether the fair agreement arbitration condition is accepted or not by the first clients through a reply function of the E-mail or text message.

In addition, when the trade price is decided by accepting the negotiation data of the other party or the fair agreement arbitration condition is accepted by the first clients 50 to 52 and second clients 60 to 62, by confirming trade details and approval details for the decided trade price or the fair agreement arbitration condition and by registering them into the database server 40 (ST800), smooth electronic commerce for the price negotiations can be realized.

Here, the confirmation of the approval details in the trade accomplishment step ST800 preferably further includes a signature confirmation step of registering electronic signature data for each member inputted at the time of member registration from the first clients 50 to 52 and second clients 60 to 62 and identifying a signatory by comparing the registered electronic signature data with an electronic signature received at the time of approval of the credit card for the purpose of security of approval of the credit card.

In addition, since electronic approval or delivery confirmation of the first clients 50 to 52 and second clients 60 to 62 according to the trade details and the approval details after the trade accomplishment step ST800 is well known to those skilled in the art, detailed descriptions thereof will be omitted.

Although the preferred embodiment of the present invention has been described for illustrative purposes, various changes, modifications and equivalents can be made thereto. It is apparent that the preferred embodiment can be properly modified and the modifications can be equivalently applied. Therefore, the description does not limit the scope and spirit of the invention defined by the appended claims.

As described above, an electronic commerce system and method for negotiating a price on a network according to the present invention have an advantage in that a fair and reasonable price of goods can be decided through convergence of a variety of opinions and conditions in the 1 to 1 price negotiations between the first clients which have registered the goods to be sold or purchased on the network and the second clients which wish to participate in price negotiations for the registered goods.

Furthermore, the present invention has an advantage in that reasonable electronic commerce can be provided between sellers and purchasers by reflecting not only the trade quantity and price of the goods but also other trade factors such as the goods delivery term, quality guaranteed term, returns conditions, payment means, package level, and the number of the recommended, onto the electronic commerce.

In addition, the present invention has an advantage in that close trade which has not yet been found in conventional electronic commerce can be made between sellers and purchasers by progressing the 1 to 1 price negotiations between the sellers and the purchasers in a non-opened manner.

Moreover, the present invention has an advantage in that negotiation data for accomplishing the 1 to 1 price negotiations are proposed between the sellers and the purchasers by providing the degrees of negotiation intention of both the sellers and the purchasers in the price negotiations between the sellers and the purchasers.

Additionally, the present invention has an advantage in that the time required for the price negotiations can be saved and users who are not accustomed to the price negotiations are allowed to perform the electronic commerce with reasonable price negotiations by automatically executing reasonable price negotiations for registered goods on behalf of the sellers or purchasers.

Furthermore, the present invention has an advantage in that a wholesome electronic commerce environment is provided by preventing tiresome price negotiations through a limitation on the negotiation term or the number of proposals of negotiation data in the 1 to 1 price negotiations between the sellers and the purchasers.

Moreover, the present invention has an advantage in that a success possibility of trade is raised by proposing an agreement arbitration condition with most objective condition to the sellers and the purchasers even when trade is not accomplished in the 1 to 1 price negotiations between the sellers and the purchasers.

Furthermore, the present invention has an advantage in that it contributes to activation of the electronic commerce through active participation of the users by allowing the users to simply input negotiation data without fully inputting data on goods to be sold or purchased as in the conventional electronic commerce.

Explanations of Reference Numerals for Major Components in the Drawings

10: Electronic commerce system

20: Negotiation management server

23: Control unit

25: Electronic shopping mall

27: Communication unit

30: Price negotiation engine

33: Registration module

35: Negotiation progress module

37: Calculation module

40: Database server

43: Member database

45: Registered goods database

47: Negotiation management database

50, 51, 52: First clients

60, 61, 61: Second clients What is claimed is:

1. A method of electronic bargaining for sale of goods, comprising:
receiving, by a server for an electronic bargaining web site, information about goods for sale and a seller's price range for sale of the goods, wherein the seller's price range is defined by highest and lowest selling prices;
posting the goods for sale on the web site with a proposed selling price, wherein the proposed selling price is the highest selling price, wherein the web site allows a buyer connecting to the web site using a computer to initiate a bargaining process for the sale of the goods posted on the web site, and wherein the web site allows the buyer either to accept the proposed selling price or to input a buyer's desired price;
receiving, by the server, the buyer's desired price;
determining whether the buyer's desired price falls within the seller's price range including the highest and lowest selling prices;
formulating, by the server, a seller's adjusted price if the buyer's desired price is below the lowest selling price, wherein the seller's adjusted price is lower than the proposed selling price and within the price range;
transmitting to the buyer's computer the seller's adjusted price so that the seller's adjusted price is displayed on the buyer's computer, wherein the web site allows the buyer to accept the seller's adjusted price or to input a buyer's adjusted price;
receiving, by the server, the buyer's adjusted price for further bargaining;
determining whether the buyer's adjusted price falls within the seller's price range including the highest and lowest selling prices;
formulating, by the server, a seller's further adjusted price if the buyer's adjusted price is below the lowest selling price, wherein the seller's further adjusted price is lower than the seller's adjusted price and within the price range; and
transmitting to the buyer's computer the seller's further adjusted price so that the seller's further adjusted price is displayed on the buyer's computer, wherein the web site allows the buyer to accept the seller's further adjusted price or to input a buyer's further adjusted price.

2. A method of electronic bargaining for sale of goods, comprising:
receiving, by a server for an electronic bargaining web site, a buyer's desired price of goods posted on the web site;
determining whether the buyer's desired price falls within a predetermined price range of the goods, the price range including highest and lowest selling prices thereof; and
if the buyer's desired price is below the lowest selling price, transmitting to the buyer a seller's adjusted price that is lower than the highest selling price and within the price range.

3. The method of claim 2, wherein the seller's adjusted price is provided by a seller of the goods in reply to the buyer's desired price.

4. The method of claim 2, wherein the seller's adjusted price is provided by a seller of the goods prior to the receipt of the buyer's desired price.

5. The method of claim 2, wherein the seller's adjusted price is automatically formulated by the server.

6. The method of claim 2, wherein the server formulates the seller's adjusted price substantially immediately upon receipt of the buyer's desired price.

7. The method of claim 2, further comprising receiving, by the server, a buyer's desired quantity along with the buyer's desired price.

8. The method of claim 7, wherein the seller's adjusted price is formulated such that the seller's adjusted price decreases when the buyer's desired quantity increases.

9. The method of claim 2, wherein the predetermined price range is provided by a seller.

10. The method of claim 2, further comprising receiving from the buyer a buyer's acceptance to the seller's adjusted price.

11. The method of claim 2, further comprising transmitting to the buyer an acceptance to the buyer's desired price if the buyer's desired price falls within the price range.

12. The method of claim 2, further comprising repeating the method with respect to the same buyer.

13. The method of claim 12, wherein the method is repeated to a fixed number of times.

14. The method of claim 13, wherein after the fixed number of repetitions, the method further comprises:
formulating a server's proposed sale price based on the price range and the buyer's desired price in each repetition; and
transmitting the server's proposed sale price to the buyer for acceptance.

15. The method of claim 14, further comprising receiving an acceptance of the buyer to the server's proposed sale price.

16. The method of claim 14, further comprising transmitting the server's proposed sale price to a seller of the goods for acceptance.

17. The method of claim 16, further comprising receiving an acceptance of the seller to the server's proposed sale price.

18. The method of claim 14, wherein the proposed sale price is lower than or equal to the lowest selling price.

19. The method of claim 14, wherein the proposed sale price is higher than the lowest selling price.

20. The method of claim 2, further comprising receiving from the buyer either a buyer's adjusted price or a buyer's acceptance to the seller' adjusted price.

21. The method of claim 20, further comprising transmitting the buyer's acceptance to the seller upon receipt thereof.

22. The method of claim 20, further comprising, upon receipt of the buyer's adjusted price, determining whether the buyer's adjusted price falls within the price range including the highest and lowest selling prices.

23. The method of claim 22, further comprising:
in case the buyer's adjusted price falls within the price range, transmitting to the buyer an acceptance to the buyer's adjusted price; and
in case the buyer's adjusted price is below the lowest selling price, transmitting to the buyer seller's another adjusted price that is lower than the seller's adjusted price and within the price range.

24. The method of claim 2, wherein if the buyer's desired price falls within the price range, the method further comprises transmitting, by the seller, a seller's acceptance to the buyer.

25. The method of claim 24, wherein the seller's acceptance is substantially immediately transmitted by the server.

26. The method of claim 24, further comprising receiving, by the server, a buyer's confirmation to the seller's acceptance.

27. The method of claim 26, further comprising processing for payment of the accepted price.

28. The method of claim 26, further comprising transmitting the buyer's confirmation to a seller of the goods.

29. A system for electronic bargaining for sale of goods, comprising:
means for storing information identifying goods for sale and a price range defined by highest and lowest selling prices of the goods;
means for receiving a desired price of goods for sale;
means for determining whether the desired price falls within the price range including the highest and lowest selling prices;
means for formulating an adjusted selling price that is lower than the highest selling price and within the price range; and
means for transmitting the adjusted selling price.

30. A method for electronic bargaining for sale of goods, comprising:
connecting, by a buyer, to an electronic bargaining web site on a server;
locating, by the buyer, goods to buy and a selling price of the goods posted on the web site;
transmitting, from the buyer, to the server a buyer's desired price for the goods;
receiving, by the buyer, either a seller's acceptance to the buyer's desired price or a seller's adjusted price for further bargaining; and
in case of receipt of the seller's adjusted price, transmitting, from the buyer, to the server either a buyer's acceptance to the seller's adjusted price or a buyer's adjusted price for further bargaining.

31. The method of claim 30, wherein the server automatically formulates and transmits the seller's acceptance to the buyer when the buyer's desired price is within a predetermined price range for acceptance.

32. The method of claim 30, wherein the seller's acceptance is received by the buyer substantially immediately after the buyer's transmitting the buyer's desired price.

33. The method of claim 30, wherein the seller's adjusted price is automatically formulated by the server such that the seller's adjusted price is higher than the buyer's desired price and within a predetermined price range provided by the seller to the server.

34. The method of claim 33, wherein the seller's adjusted price is received by the buyer substantially immediately after the buyer's transmitting the buyer's desired price.

35. The method of claim 30, wherein the seller's adjusted price is originated from the seller.

36. The method of claim 30, wherein the seller is a person who has registered for electronic bargaining of the goods by providing information about the goods and a price.

37. The method of claim 30, wherein the server comprises a plurality of components, one or more of which are located in different locations.

38. The method of claim 30, further comprising receiving, by the buyer, from the server a server's proposed sale price in case of no acceptance by either the buyer or seller.

39. A method for electronic bargaining, comprising:
causing, by a buyer, to transmit information identifying the buyer's desired goods to a server for an electronic bargaining web site, wherein at least part of the information for identifying the buyer's desired goods is posted on the electronic bargaining web site;
receiving, by the buyer, a seller's desired price for selling the goods by a seller, wherein the buyer receives the seller's desired price through the web site;
transmitting, from the buyer, to the server either a buyer's acceptance to the seller's desired price or a buyer's adjusted buying price; and
receiving, by the buyer, either a seller's acceptance to the buyer's adjusted buying price or a seller's adjusted price.

40. The method of claim 39, further comprising transmitting, from the buyer, to the server a buyer's price range for accepting a seller's desired price falling within the price range.

41. The method of claim 39, further comprising transmitting, from the buyer, to the server a quantity of the goods that the buyer desires to buy.

42. The method of claim 39, wherein the seller is a person connecting to the server of the electronic bargaining web site and participating in the electronic bargaining to sell the buyer's desired goods to the buyer.

43. The method of claim 39, wherein the buyer causes to transmit the information from another web site posting the buyer's desired goods.

44. The method of claim 43, wherein the transmission of the information comprises running a software configured to retrieve information from a web site and to initiate transmission of at least part of the retrieved information to the electronic bargaining web site.

45. The method of claim 43, wherein the other web site further discloses a price for the buyer's desired goods.

46. The method of claim 43, further comprising transmitting, from the buyer or the server of the electronic bargaining web site, to a server of the other web site a notice that the buyer's desired goods are posted for bargaining at the electronic bargaining web site.

47. The method of claim 43, further comprising transmitting, from the buyer or the server of the electronic bargaining web site, to a person who posted the buyer's desired goods on the other web site a notice that the buyer's desired goods are posted for bargaining at the electronic bargaining web site.

48. The method of claim 39, wherein the server comprises a plurality of components, one or more of which are located in different locations.

49. A method for electronic bargaining for sale of goods, comprising:
connecting, by a seller, to an electronic bargaining web site on a server;
transmitting, by the seller, to the server information for registering for an electronic sale of goods, wherein the information comprises identification of the goods and a seller's desired price for the goods, wherein at least part of the information is posted on the electronic bargaining web site;
receiving, by the seller, a buyer's desired price; and
transmitting, from the seller, to the server either a seller's adjusted price for further bargaining or a seller's acceptance to the buyer's desired price.

50. The method of claim 49, wherein the buyer is a person connecting to the electronic bargaining web site and participating in the electronic bargaining to buy the goods from the seller.

51. The method of claim 49, wherein the server comprises a plurality of components, one or more of which are located in different locations.

52. The method of claim 49, further comprising receiving, by the seller, either a buyer's adjusted price for further bargaining or a buyer's acceptance to the seller's adjusted price.

53. The method of claim 52, further comprising receiving, by the seller, a server's proposed sale price in case of no acceptance by either the buyer or seller.

54. The method of claim 53, further comprising receiving, by the seller, a buyer's acceptance to the server's proposed sale price.

55. The method of claim 53, further comprising transmitting, from the seller, a seller's acceptance to the server's proposed sale price.

56. The method of claim 52, further comprising transmitting, from the seller, to the server either seller's another adjusted price for further bargaining or a seller's acceptance to the buyer's adjusted price.

57. The method of claim 56, further comprising receiving by the seller from the server either buyer's another adjusted price or a buyer's acceptance to the seller's other adjusted price.

58. The method of claim 49, wherein the information further comprises a quantity of the goods for sale.

59. A method for an electronic sale of goods, comprising:
connecting, by a seller, to an electronic bargaining web site on a server;
transmitting, from the seller, to the server information for registering for an electronic sale of goods, wherein the information comprises identification of goods for sale and a price range for electronic bargaining, wherein at least part of the information is to be posted on the electronic bargaining web site; and
receiving, by the seller, from the server an acceptance by a buyer to a price, which is formulated by the server with use of the price range and a price proposed by the buyer.

60. The method of claim 59, wherein the server-formulated price is within the price range transmitted by the seller.

61. The method of claim 59, wherein the server formulated price is below the lower limit of the price range.

62. The method of claim 61, further comprising transmitting, by the seller, to the server a seller's acceptance to the server formulated price.

63. The method of claim 59, wherein the buyer is a person connecting to the electronic bargaining web site and participating in the electronic bargaining to buy the goods.

64. The method of claim 59, wherein the server comprises a plurality of components, one or more of which are located in different locations.

65. An electronic commerce system for negotiating a price on a network, comprising:
a negotiation management server for operating an electronic shopping mall which is connected to first and second clients through a network and in which a trade price is decided by 1 to 1 price negotiations between the first and second clients, and controlling a series of functions for the 1 to 1 price negotiations between the first and second clients;
a price negotiation engine controlled by the negotiation management server and including a registration module for receiving and registering data on goods to be sold or purchased and data on a negotiation environment inputted from the first clients, a negotiation progress module for selecting any of the second clients which wishes to participate in the price negotiations and then displaying a negotiation window through which negotiation data proposing the quantity and price of the goods in the price negotiations are inputted so that the price negotiations between the first and second clients is progressed, and a calculation module for receiving the negotiation data proposing the quantity and price of the goods from the first and second clients through the negotiation window, calculating a fair negotiation unit price based on the received negotiation data and the negotiation environment data, and calculating and outputting the degree of negotiation intention as the degree of access to the price negotiations by comparing and analyzing the fair negotiation unit price and the negotiation data; and
a database server controlled by the negotiation management server for storing member information on the first and second clients subscribing as members, registered goods information on the goods data and the negotiation environment data of the registered goods to be sold or purchased from the first clients, and negotiation management information on negotiation history, trade details and approval details in the price negotiations between the first and second clients.

66. The electronic commerce system as claimed in claim 65, wherein the database server comprises:
a member database for the member information consisting of member basic data including IDs, passwords and basic personalities received through member subscription from the first and second clients and member trade data including progress situations, trade details, approval details, credit levels and electronic signatures for each member for the price negotiations between the first and second clients;
a registered goods database for the registered goods information consisting of goods data including a goods kind, a goods name, an open market price for the goods and goods presentation and negotiation environment data including a registration quantity, a desired highest unit price, a desired lowest unit price, a negotiation way and a negotiation term for the goods data; and
a negotiation management database for the negotiation management information consisting of history for each negotiations, price negotiation results, and trade details, approval details and delivery details according to the price negotiation results in the price negotiations between the first and second clients.

67. The electronic commerce system as claimed in claim 65, wherein when the goods to be sold or purchased by the first clients are selected through a goods search of a price comparison service server, the registration module of the price negotiation engine further includes
an automatic registration module for receiving goods data on the selected goods from the price comparison service server, classifying the received data into a goods kind, a goods name, an open market price for the goods and goods presentation, and automatically inputting the classified data into a goods registration screen.

68. The electronic commerce system as claimed in claim 65, wherein when plug-in applications for a web browser using a proxy technology are provided to the first clients and the first clients, which have been provided with the plug-in applications, request registration of goods to be sold or purchased by use of the plug-in applications while surfing the Internet shopping mall, the registration module of the price negotiation engine further includes:
a proxy automatic registration module for extracting data on goods requested to be registered from the Internet shopping mall, classifying the extracted data into a goods kind, a goods name, an open market price for the goods and goods presentation, and automatically inputting the classified data into a goods registration screen.

69. The electronic commerce system as claimed in claim 65, wherein when the negotiation data proposing the quantity and price of the goods are inputted from the second clients, the negotiation progress module of the price negotiation engine further includes:
an automatic negotiation module for displaying the inputted negotiation data and the corresponding degree of negotiation intention, and automatically generating and displaying the negotiation data on the quantity and price of the goods corresponding to the degree of negotiation intention of the second clients in place of the negotiation data proposed by the first clients.

70. An electronic commerce method for deciding a trade price through price negotiations between first and second clients connected via a network in an electronic commerce system, comprising:
a member authentication step of confirming members when the first and second clients are connected via the network;
after the member authentication step, when goods data for goods to be sold and purchased and negotiation environment data as negotiation materials are inputted from the first clients, a registration step of registering the inputted goods data and negotiation environment data as trade goods into a database server;
after the registration step, when the second clients select the registered goods in order to participate in the price negotiations, a display step of displaying a negotiation window for allowing the first and second clients to input negotiation data proposing the quantity and price of the goods;
after the display step, when the negotiation data proposing the quantity and price of the goods are inputted from the first and second clients, a price negotiation step of calculating a fair agreement unit price based the inputted negotiation data and the negotiation environment data, comparing and analyzing the calculated fair agreement unit price and the negotiation data, and displaying the degree of negotiation intention as the degree of access to the price negotiations;
after the price negotiation step, a negotiation progress determination step of, when it is confirmed that the negotiation data proposed by the other party are accepted by the first or second clients, deciding a trade price based on the accepted negotiation data and then ending the price negotiations, and when it is confirmed that the negotiation data proposed by the other party are not accepted by the first or second clients, confirming a predetermined negotiation term or the number of proposals of the negotiation data and determining whether the price negotiations is further progressed or not;
after the negotiation progress determination step, when it is confirmed that the trade price is not decided for the ended price negotiations, a price negotiation arbitration step of proposing a fair agreement arbitration condition for the quantity and price of the goods generated based on price negotiation history and negotiation environment data to the first and second clients and acquiring a confirmation as to whether the agreement arbitration condition is accepted or not by the first and second clients; and
when the trade price is decided for the price negotiations ended after the negotiation progress determination step, or when the proposed agreement arbitration condition is accepted by the first and second clients after the price negotiation arbitration step, a trade accomplishment step of confirming the decided trade price or the trade details and the approval details for the agreement arbitration conditions and then registering them into the database server.

71. The electronic commerce method as claimed in claim 70, wherein the registration step comprises the steps of:
selecting the goods to be sold or purchased by the first clients through a goods search of a price comparison service server;
receiving goods data on the selected goods from the price comparison service server, classifying the received data into a goods kind, a goods name, an open market price for the goods and goods presentation, and automatically inputting the classified data; and
receiving and registering negotiation environment data including a registration quantity, a desired highest unit price, a desired lowest unit price, a negotiation way, and a negotiation term for the goods data from the first clients.

72. The electronic commerce method as claimed in claim 70, wherein the registration step comprises the steps of:
confirming goods to be sold or purchased and requesting goods registration by use of plug-in applications while surfing the Internet shopping mall through web browsers of the first clients provided with the plug-in applications for web browsers using a proxy technology;
extracting data on goods requested to be registered from the Internet shopping mall, classifying the extracted data into a goods kind, a goods name, an open market price for the goods and goods presentation, and automatically inputting the classified data; and
receiving negotiation environment data including a registration quantity, a desired highest unit price, a desired lowest unit price, a negotiation way, and a negotiation term for the goods data from the first clients, and registering the goods.

73. The electronic commerce method as claimed in claim 72, wherein after the goods registration step, the registration step further comprises a goods registration notification step of automatically forwarding an E-mail telling the goods registration completion to the Internet shopping mall so that the persons concerned in the Internet shopping mall can participate in the price negotiations.

74. The electronic commerce method as claimed in claim 70, wherein the price negotiation step comprises the steps of:
when the negotiation data proposing the quantity and price of the goods to the other party from the first or second clients are inputted, calculating a fair agreement unit price based on the inputted negotiation data and the negotiation environment data; and
calculating the degree of negotiation intention as the degree of access to the price negotiations by comparing and analyzing the calculated fair agreement unit price and the negotiation data, and displaying the negotiation data and the degree of negotiation intention through a negotiation window.

75. The electronic commerce method as claimed in claim 70, wherein the price negotiation step comprises the steps of:
when the negotiation data proposing the quantity and price of the goods to the first clients from the second clients are inputted, calculating a fair agreement unit price based on the inputted negotiation data and the negotiation environment data;
calculating the degree of negotiation intention as the degree of access to the price negotiations by comparing and analyzing the calculated fair agreement unit price and the negotiation data, and displaying the negotiation data and the degree of negotiation intention of the second clients through a negotiation window; and
generating the negotiation data corresponding to the degree of negotiation intention instead of the price negotiations of the first clients and automatically displaying the generated negotiation data and the corresponding degree of negotiation intention.

76. The electronic commerce method as claimed in claim 75, wherein after the automatic display step, when the second clients accept the automatically displayed negotiation data, the price negotiation step further comprises the step of forwarding E-mails or text messages telling trade details for the accepted negotiation data to the first clients and acquiring a confirmation as to whether the accepted negotiation data are accepted or not by the first clients through a reply function of the forwarded E-mails or text messages.

77. The electronic commerce method as claimed in claim 75, wherein the negotiation data and the degree of negotiation intention of the first clients and the negotiation data and the degree of negotiation intention of the second clients are simultaneously displayed on the negotiation windows of the first and second clients in real time.

78. The electronic commerce method as claimed in claim 70, wherein the negotiation progress determination step comprises the steps of:
when it is confirmed that the negotiation data proposed by the other party are accepted by the first or second clients, deciding a trade price based on the accepted negotiation data and then ending the price negotiations, and when it is confirmed that the negotiation data proposed by the other party are not accepted by the first or second clients, confirming a predetermined negotiation term;
when the predetermined negotiation term is ended, ending the price negotiations, and when the predetermined negotiation term is not ended, confirming the number of proposals of negotiation data of the first and second clients; and
when the number of proposals of negotiation data reaches a limited number, ending the price negotiations, and when the number of proposals of negotiation data does not reach the limited number, continuing to progress the price negotiations between the first and second clients.

79. The electronic commerce method as claimed in claim 70, wherein the price negotiation arbitration step comprises the steps of:
when the trade price is not decided for the ended price negotiations, calculating a fair agreement arbitration condition for the quantity and price of the goods based on the price negotiation history and the negotiation environment data; and
proposing the calculated agreement arbitration condition to the first and second clients and acquiring a confirmation as to whether the proposed agreement arbitration condition is accepted or not by the first and second clients.

80. The electronic commerce method as claimed in claim 70, wherein the confirmation of the approval details in the trade accomplishment step is performed through a signature confirmation step of registering electronic signature data for each member inputted at the time of member registration from the first and second clients and identifying a signatory by comparing the registered electronic signature data with an electronic signature received at the time of approval of a credit card for the purpose of security of approval of the credit card.

81. The electronic commerce method as claimed in claim 70, wherein when the second clients input the negotiation data including a goods delivery term, a quality guaranteed term, returns conditions, payment means, or the number of the recommended, the inputted negotiation data are reflected on calculation of the fair agreement unit price.

82. The electronic commerce method as claimed in claim 81, further comprising, after the trade accomplishment step, the step of forwarding advertise-purposed E-mails allowing direct purchase and approval or direct participation in the price negotiations without any log-in.
